(19) United States
(12) Patent Application Publication
(10) Pub. No.: US 2022/0276671 A1
(43) Pub. Date: Sep. 1, 2022

(54) The Clock Domain System of Interconnected Dies and Its Management Methods

(71) Applicant: 58th Research Institute of China Electronics Technology Group Corporation, Wuxi, Jiangsu (CN)

(72) Inventors: Jinghe Wei, Wuxi, Jiangsu (CN); Letian Huang, Wuxi, Jiangsu (CN); Zhiqiang Xiao, Wuxi, Jiangsu (CN); Xiaohang Wang, Wuxi, Jiangsu (CN); Mingang Feng, Wuxi, Jiangsu (CN); De Liu, Wuxi, Jiangsu (CN)

(21) Appl. No.: 17/626,821

(22) PCT Filed: Dec. 16, 2021
(86) PCT No.: PCT/CN2021/138698

§ 371 Date: Jan. 13, 2022

(30) Foreign Application Priority Data
Feb. 5, 2021 (CN) 202110160498.8

(51) Int. Cl. G06F 1/12; G06F 13/40

(52) U.S. Cl. CPC G06F 1/12; G06F 13/4059

(57) ABSTRACT

The invention discloses clock management of chips, in particular to the clock domain system of interconnected dies and its management methods. The clock domain systems of the interconnected dies, comprising: global clock domains used to manage interior networks on die of the interconnected dies, standard protocol interface clock domains used to manage standard protocol conversion modules and interface source synchronous clock domains used to manage expansion synchronization controllers across dies. The clock domain systems of the interconnected dies provided by the invention modularize complicated clock networks by isolating each module from the perspective of clocks and simultaneously initiate clock synchronization among all clock domains, which is easy for interconnected network setups.

### BACKGROUND OF THE INVENTION

### 1. Field of the Invention

The invention relates to clock management of chips, in particular to the clock domain system of interconnected dies and its management methods.

### 2. Description of the Related Art

In monolithic proprietary integrated circuits, all elements are designed and manufactured with one same technology on one silicon chip. As the technological size shrinks, costs and development periods to develop the integrated circuits become extremely high. In this situation, multi-die integration is the inevitable choice, namely interconnecting and assembling multiple verified and unpackaged chip components with various functions and packaging them as a whole chip in one same package, thus forming NoP (Network on Package). These dies can adopt different technologies, from different manufacturers, so the development period and difficulty are greatly shortened and reduced. The difficult point of multi-die integration is the communication problem among all dies and among various functional dies.

### SUMMARY OF THE INVENTION

To solve the above problems, the invention provides a clock domain system of interconnected dies, dividing clock domains and solving the problem of communications across clock domains among different clock domains, so that high-speed communications among all interfaces and among different dies are realized, the source-synchronous feature of interfaces across dies is satisfied and the flexible expansion of the interconnected dies is realized, which lays the foundation for multi-die cascades.

Specific technical schemes are as follows:

clock domain systems of the interconnected dies, comprising: global clock domains, standard protocol interface clock domains and interface source synchronous clock domains both connected with the global clock domains; the global clock domains are used to manage interior networks on die of the interconnected dies; the standard protocol interface clock domains are used to manage standard protocol conversion modules; the interface source synchronous clock domains are used to manage expansion synchronization controllers across dies.

Preferably, the global clock domains and the standard protocol interface clock domains are connected by asynchronous Buffer, two ends of the asynchronous Buffer are provided with FSM, and the global clock domains and the standard protocol interface clock domains control data transmission by their respective FSM.

Preferably, the expansion synchronization controllers across dies comprise asynchronous Buffer and bidirectional LVDS, and the asynchronous Buffer is respectively connected with buses on die and bidirectional LVDS of the interconnected dies, two ends of the asynchronous Buffer are provided with FSM, and the global clock domains and the interface source synchronous clock domains control data transmission by their respective FSM, the bidirectional LVDS is used for the generation and integration of differential signaling.

Further, the asynchronous Buffer is asynchronous dual-port RAM.

Management methods of the clock domains of the interconnected dies, wherein the clocks of the interconnected dies are divided into the global clock domains, the standard protocol interface clock domains and the interface source synchronous clock domains; the global clock domains are used to manage interior networks on die of the interconnected dies; the standard protocol interface clock domains are used to standard protocol conversion modules; the interface source synchronous clock domains are used to manage expansion synchronization controllers across dies; the global clock domains and the standard protocol interface clock domains are used to control communications between networks on die and protocol conversion modules; the global clock domains and the interface source synchronous clock domains are used to control communications among the interconnected dies.

The invention possesses the following beneficial effects compared to the current technology:

the clock domain systems of the interconnected dies provided by the invention modularize complicated clock networks by isolating each module from the perspective of clocks and simultaneously initiate clock synchronization among all clock domains, which is easy for interconnected network setups, so that high-speed communications between networks on chip and each interface and between dies are realized, the source-synchronous feature of interfaces across dies is satisfied, also with good interface universality, the expandability of the interconnected dies is greatly enhanced and the interconnected dies can be expanded flexibly, which lays the foundation for setups of networks on package.

### BRIEF DESCRIPTION OF THE DRAWINGS

FIG. 1 is a structural schematic diagram of the clock domain systems of the interconnected dies;

FIG. 2 is a processing schematic diagram of the global clock domains and the interface source synchronous clock domains;

FIG. 3 is a processing schematic diagram of the global clock domains and the standard protocol interface clock domains;

FIG. 4 is a processing schematic diagram of the interconnected die expansion adopting RAM;

FIG. 5 is a processing schematic diagram of LVDS;

FIG. 6 is a structural schematic diagram of the interconnected dies.

### DESCRIPTION OF EMBODIMENTS

A further description of the invention is given in combination with the attached drawings.

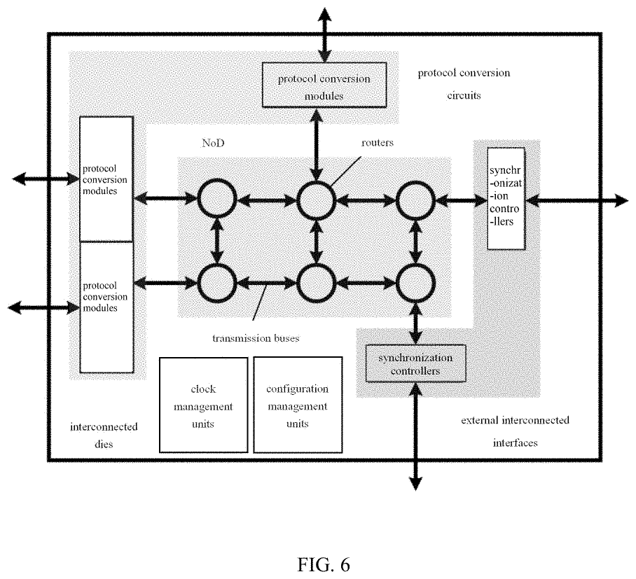

As FIG. 6 shows, the interconnected dies can easily realize data transmission, interface expansion and inter-die cascades. The interior of the interconnected dies is a network on die (Network on Die, NoD), comprised of transmission buses and routers. Particularly, the interconnected dies comprise protocol conversion circuits and interior networks on die, and the protocol conversion circuits comprise multiple protocol conversion modules, used to provide various standard mainstream protocol interfaces connected with the exterior; the interior networks on die comprise the transmission buses and routers, and the protocol conversion modules are respectively connected with boundary nodes of the interior networks on die, used to transmit data packets from the interfaces. NoD is used for data routes and high-speed transmission. Simultaneously the protocol conversion circuits convert NoD protocols into mainstream protocols, used to connect with other functional dies.

Multi-die interconnections relate to multiple NoD, and in NoD, main interconnected networks, each standard protocol interface and inter-chip routing put different requirements on clocks, which overall presents the structure of global asynchronization and local synchronization, and completely realizing the structure need precisely divide clock domains of the interconnected networks, isolate each module from the perspective of clocks, and then connect and integrate the modules of each clock domain using the corresponding solutions across clock domains, and finally the complete interconnected networks are formed.

The interconnected dies use networks on die as the core, plus the actually usable dies comprised of various standard protocol interface conversions, configuration units, clock management and other circuits, so that by the division of NoD network clock domains and the handling of communications across clock domains among different clock domains, the high-speed communication problem between networks on chip of the interconnected dies and each interface and between various dies is solved, the source-synchronous feature of interfaces across dies is satisfied, and the interconnected dies can be expanded flexibly, which lays the foundation for multi-die cascades.

### Embodiment 1

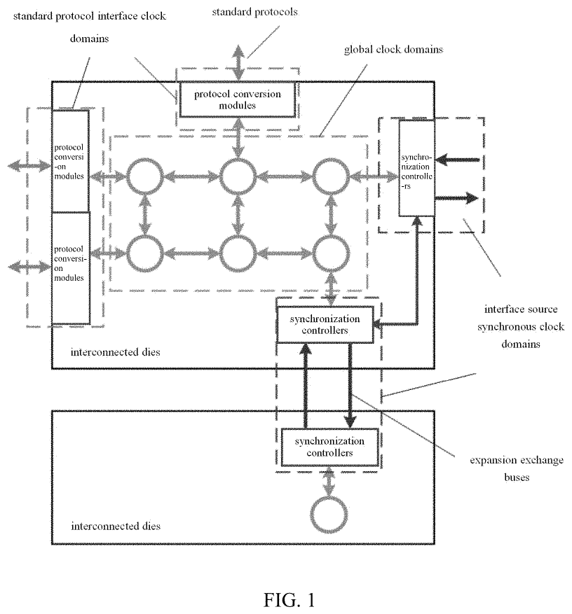

As FIG. 1 to FIG. 5 show, clock domain systems of the interconnected dies, comprising: global clock domains, standard protocol interface clock domains and interface source synchronous clock domains both connected with the global clock domains; the global clock domains are used to manage interior networks on die of the interconnected dies; the standard protocol interface clock domains are used to manage standard protocol conversion modules; the interface source synchronous clock domains are used to manage expansion synchronization controllers across dies.

The global clock domains and the standard protocol interface clock domains are connected by asynchronous Buffer, two ends of the asynchronous Buffer are provided with FSM, and the global clock domains and the standard protocol interface clock domains control data transmission by their respective FSM.

The expansion synchronization controllers across dies comprise asynchronous Buffer and bidirectional LVDS, and the asynchronous Buffer is respectively connected with buses on die and bidirectional LVDS of the interconnected dies, two ends of the asynchronous Buffer are provided with FSM, and the global clock domains and the interface source synchronous clock domains control data transmission by their respective FSM, the bidirectional LVDS is used for the generation and integration of differential signaling.

The asynchronous Buffer is asynchronous dual-port RAM.

The global clock domains comprise all routers and transmission buses in NoD, and the transmission buses are also called buses on die.

The standard protocol interface clock domains are provided with different clock domains according to the standard protocols.

The interface source synchronous clock domains are divided into two clock domains, namely input channels and output channels, respectively belonging to the separate and independent clock domain.

As FIG. 1 shows, known from the planning of NoD clock domains, the global clock domains respectively interact with the interface source synchronous clock domains and the standard protocol interface clock domains, so solutions across clock domains comprise the handling between the global clock domains and the interface source synchronous clock domains and the handling between the global clock domains and the standard protocol interface clock domains.

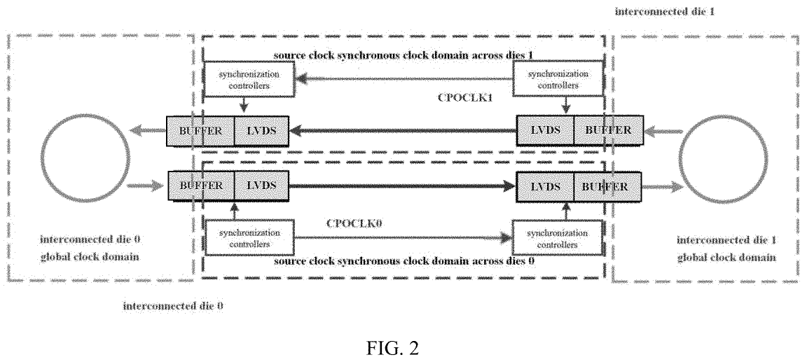

As FIG. 2 shows, the handling between the global clock domains and the interface source synchronous clock domains, and the expansion synchronization controllers across dies, for connections across dies, comprise asynchronous Buffer and bidirectional LVDS (Low Voltage Differential Signaling), the asynchronous Buffer is used to isolate the global clock domains and LVDS clock domains, namely the interface source synchronous clock domains, and the bidirectional LVDS is used for the generation and integration of differential signaling to ensure the high-speed communications among interconnected dies.

The asynchronous Buffer is used to connect buses on die and LVDS, two sides of Buffer comprise respectively a state machine with the separate clock domain to transmit and control, and simultaneously two channels of buses on die respectively belong to the separate independent clock domain: the clock signals of the source clock synchronous clock domain across dies 1 are sent by the expansion synchronization controllers across dies of the interconnected die 1, and simultaneously the input Buffer of the interconnected die 0 and the output Buffer of the interconnected die 1 are driven; the clock signals of the source clock synchronous clock domain across dies 0 are sent by the expansion synchronization controllers across dies of the interconnected die 0, and simultaneously the output Buffer of the interconnected die 0 and the input Buffer of the interconnected die 1 are driven.

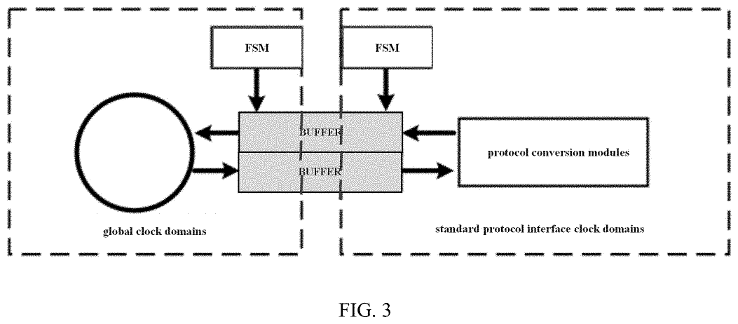

As FIG. 3 shows, the handling between the global clock domains and the standard protocol interface clock domains, and the asynchronous Buffer is used to connect buses on die and standard bus protocol (such as EMMC interface, DDR3/4 interface, PCIe interface, etc.) conversion modules, and two sides of Buffer comprise respectively a state machine with the separate clock domain to transmit and control.

The above methods solve the problems across clock domains between different standard protocol interfaces and networks on chip and between dies, with good universality and high expandability.

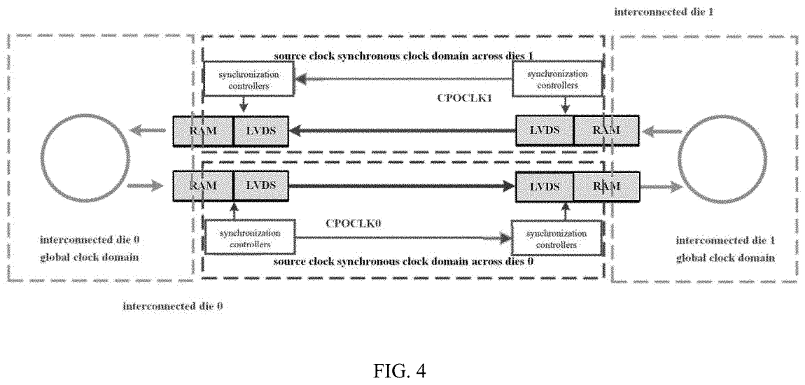

As FIG. 4 shows, the function of expanding the synchronization controllers across dies is to isolate the clock domain, so the asynchronous dual-port RAM is chosen as the Buffer of the expansion synchronization controllers across dies.

The access among the interconnected dies adopts the configurable bidirectional LVDS transmission, and the data are transmitted by the differential signaling, with the advantages of low power consumption, low error rate, low crosstalk, low radiation and so on.

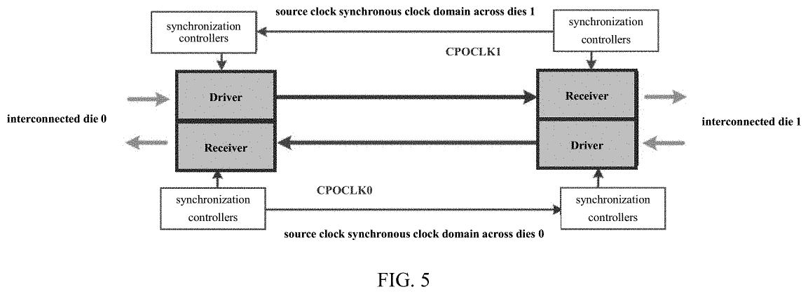

FIG. 5 shows the structure of the configurable bidirectional LVDS, and LVDS of each interconnected die comprises drivers and receivers, the drivers are responsible for differential signaling generation and the receivers are responsible for differential signaling integration.

### Embodiment 2

Management methods of the clock domains of the interconnected dies, wherein the clocks of the interconnected dies are divided into the global clock domains, the standard protocol interface clock domains and the interface source synchronous clock domains; the global clock domains are used to manage interior networks on die of the interconnected dies; the standard protocol interface clock domains are used to manage standard protocol conversion modules; the interface source synchronous clock domains are used to manage expansion synchronization controllers across dies; the global clock domains and the standard protocol interface clock domains are used to control communications between networks on die and protocol conversion modules; the global clock domains and the interface source synchronous clock domains are used to control communications among the interconnected dies.

The advantages of the clock domain system of interconnected dies and its management methods:

1. by precisely dividing NoD network clock domains, each module is isolated from the perspective of clocks to modularize complicated clock networks, and the clock in each clock domain after isolating is synchronous while the clock in different clock domains is asynchronous, so only the clock asynchronous problem among different clock domains needs to be overcomed to solve the clock problem of the NoD networks. The division method of the clock domains simplifies the design of the NoD networks and facilitates the cascades of the NoD networks, which is easy for the whole interconnected network setups.

2. after isolating each module from the perspective of clocks, the modules of each clock domain need to be connected and integrated using the corresponding solutions across clock domains, so the high-speed communication problem between networks on chip of the interconnected dies and each interface and between various dies is solved, the source-synchronous feature of interfaces across dies is satisfied, also with good interface universality, the expandability of the interconnected dies is greatly enhanced and the interconnected dies can be expanded flexibly, which lays the foundation for setups of NoP.

The technical principles of the invention are described above in combination with specific embodiments. The descriptions are only for explaining the invention principles and shall not be explained in any way as limitations to the protection scope of the invention. Based on the explanation, without doing the creative work, technicians in the field can make an association with other specific embodiments of the invention, which shall all fall within the protection scope of claims of the invention.

1. Clock domain systems of the interconnected dies, comprising: global clock domains, standard protocol interface clock domains and interface source synchronous clock domains both connected with the global clock domains;
the global clock domains are used to manage interior networks on die of the interconnected dies;
the standard protocol interface clock domains are used to manage standard protocol conversion modules;
the interface source synchronous clock domains are used to manage expansion synchronization controllers across dies.

2. The clock domain systems of the interconnected dies according to claim 1, wherein the global clock domains and the standard protocol interface clock domains are connected by asynchronous Buffer, two ends of the asynchronous Buffer are provided with FSM, and the global clock domains and the standard protocol interface clock domains control data transmission by their respective FSM.

3. The clock domain systems of the interconnected dies according to claim 1, wherein the expansion synchronization controllers across dies comprise asynchronous Buffer and bidirectional LVDS, and the asynchronous Buffer is respectively connected with buses on die and bidirectional LVDS of the interconnected dies, two ends of the asynchronous Buffer are provided with FSM, and the global clock domains and the interface source synchronous clock domains control data transmission by their respective FSM, the bidirectional LVDS is used for the generation and integration of differential signaling.

4. The clock domain systems of the interconnected dies according to claim 3, wherein the asynchronous Buffer is asynchronous dual-port RAM.

5. Management methods of the clock domains of the interconnected dies, wherein,
the clocks of the interconnected dies are divided into the global clock domains, the standard protocol interface clock domains and the interface source synchronous clock domains;
the global clock domains are used to manage interior networks on die of the interconnected dies;
the standard protocol interface clock domains are used to used to manage standard protocol conversion modules;
the interface source synchronous clock domains are used to manage expansion synchronization controllers across dies;
the global clock domains and the standard protocol interface clock domains are used to control communications between networks on die and protocol conversion modules;
the global clock domains and the interface source synchronous clock domains are used to control communications among the interconnected dies.
